(19) United States
(12) Patent Application Publication
(10) Pub. No.: US 2013/0045035 A1
(43) Pub. Date: Feb. 21, 2013

(54) SHEET COMPRESSION APPARATUS AND IMAGE FORMING APPARATUS

(71) Applicant: Yoshiyasu Satomi, Toride-shi (JP)

(72) Inventor: Yoshiyasu Satomi, Toride-shi (JP)

(73) Assignee: CANON KABUSHIKI KAISHA, Tokyo (JP)

(21) Appl. No.: 13/568,781

(22) Filed: Aug. 7, 2012

(30) Foreign Application Priority Data
Aug. 18, 2011 (JP) 2011-179062

(51) Int. Cl. G03G 15/00; B30B 3/04

(52) U.S. Cl. 399/381; 100/161; 100/158 R

(57) ABSTRACT

A sheet compression apparatus disposed between a sheet feeding unit configured to feed a sheet and an image forming unit configured to form an image on the sheet compresses the sheet fed by the sheet feeding unit before the image forming unit forms the image on the sheet. The sheet compression apparatus includes a first rotator pair including a first nip configured to press the sheet and allowing a leading edge portion of the sheet to enter and pass through the first nip at a first angle inclined relative to the first nip, and a second rotator pair including a second nip configured to press the sheet and allowing the leading edge portion of the sheet to enter and pass through the second nip at a second angle inclined opposite the first angle relative to the second nip.

### BACKGROUND OF THE INVENTION

1. Field of the Invention

The present disclosure relates to a sheet compression apparatus capable of compressing an edge portion of a sheet and an image forming apparatus provided therewith.

2. Description of the Related Art

Conventionally, a sheet as a recording material used by an image forming apparatus such as a copying machine, a printer, a facsimile apparatus, and a multifunction peripheral having these functions is formed in a predetermined standard size by cutting of base paper. As a result, fibers constituting the sheet are splintered by the cutting, thus inevitably forming cutting burrs at the edge portion of the sheet.

In recent years, electrophotographic image forming apparatuses have fixing rollers and pressure rollers for fixing images, the surface layers of which are coated with fluorine resin to ensure releasability from tonner, thereby improving the qualities of the images formed on sheets. Therefore, conveying a sheet having cutting burrs through a nip of the fixing roller or the pressure roller may result in generation of damage or wear on the coating of the fixing roller or the pressure roller, thereby deteriorating the quality of the image. Especially, when a thick sheet (for example, having a grammage of 250 to 350 g/m² (gsm)) passes through the fixing roller or the pressing roller, significant damage or wear may be generated by the cutting burrs formed at the edge portion of the sheet, resulting in deterioration of the quality of the image formed on the sheet by this damage or wear.

To solve this problem, Japanese Patent Application Laid-Open No. 2010-276846 discusses a technique for disposing a roller pair on the upstream side of a fixing unit, and removing cutting burrs by pressing the burrs with use of the roller pair, thereby reducing the influence of the cutting burrs).

The roller pair discussed in Japanese Patent Application Laid-Open No. 2010-276846 is to reduce the height of the cutting burrs by pressing the cutting burrs. However, for example, a thick sheet having a grammage exceeding 300 g/m² (gsm) requires not only a reduction of the height of the cutting burrs but also a compression of the edge portion of the sheet. Otherwise, damage or wear is generated at components such as a fixing roller. To achieve an effect by the pressing force of the above-described roller pair, a torque a dozen times larger is required to power up the pressing force, and the increase of the torque may cause, for example, a driving motor to lose steps. Further, a failure of sheet conveyance may occur due to a shock when the sheet enters between the rollers.

This problem can be solved by conveying the sheet into the nip of the roller pair in an inclined state to reduce the resistance against the sheet conveyance, thereby reducing the increase of the torque and the shock at the time of the entry of the sheet. However, in this case, the edge portion of the inclined sheet on the side passing first can be successfully compressed, but the edge portion on the side passing afterward is hardly compressed, resulting in occurrence of a problem of the inability to compress the edge portion evenly.

### SUMMARY OF THE INVENTION

The present disclosure is directed to a sheet compression apparatus capable of compressing an edge portion of a sheet evenly to reduce deterioration of the quality of an image formed on the sheet, and an image forming apparatus provided therewith.

According to an aspect disclosed herein, an image forming apparatus includes a sheet feeding unit configured to feed a sheet, an image forming unit configured to form an image on the sheet fed by the sheet feeding unit, and a sheet compression apparatus disposed between the sheet feeding unit and the image forming unit and configured to compress the sheet fed by the sheet feeding unit before the image forming unit forms the image on the sheet. The sheet compression apparatus includes a first rotator pair including a first nip configured to press the sheet and allowing a leading edge portion of the sheet to enter and pass through the first nip at a first angle inclined relative to the first nip, and a second rotator pair including a second nip configured to press the sheet and allowing the leading edge portion of the sheet to enter and pass through the second nip at a second angle inclined opposite the first angle relative to the second nip.

According to an exemplary embodiment of the present disclosure, the edge portion can be evenly compressed to reduce the deterioration of the quality of the image formed on the sheet.

Further features and aspects disclosed herein will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the disclosure and, together with the description, serve to explain the principles of the disclosed embodiments.

FIG. 1 is a cross-sectional view schematically illustrating the overall configuration of a printer according to an exemplary embodiment.

FIG. 2 is a function block diagram of a sheet compression apparatus according to the present exemplary embodiment.

FIG. 3 is a perspective view illustrating the general configuration of the sheet compression apparatus according to the present exemplary embodiment.

FIG. 4 is a top view illustrating the sheet compression apparatus according to the present exemplary embodiment.

FIG. 5 is a timing chart illustrating an increase and decrease of the pressing force of the sheet compression apparatus according to the present exemplary embodiment.

FIG. 6 is a flowchart illustrating a sheet compression operation of the sheet compression apparatus according to the present exemplary embodiment.

FIG. 7A illustrates the thickness of a leading edge portion of a sheet before the sheet passes through the sheet compression apparatus.

FIG. 7B illustrates the thickness of the leading edge portion of the sheet after the sheet passes through the sheet compression apparatus.

### DESCRIPTION OF THE EMBODIMENTS

Various exemplary embodiments, features, and aspects will be described in detail below with reference to the drawings.

An image forming apparatus according to an exemplary embodiment is an image forming apparatus including a sheet compression apparatus capable of compressing an edge portion of a conveyed sheet, such as a copying machine, a printer, a facsimile apparatus, and a multifunction peripheral having these functions. Hereinafter, the following exemplary embodiment will be described with reference to an electrophotographic printer 100 as the image forming apparatus.

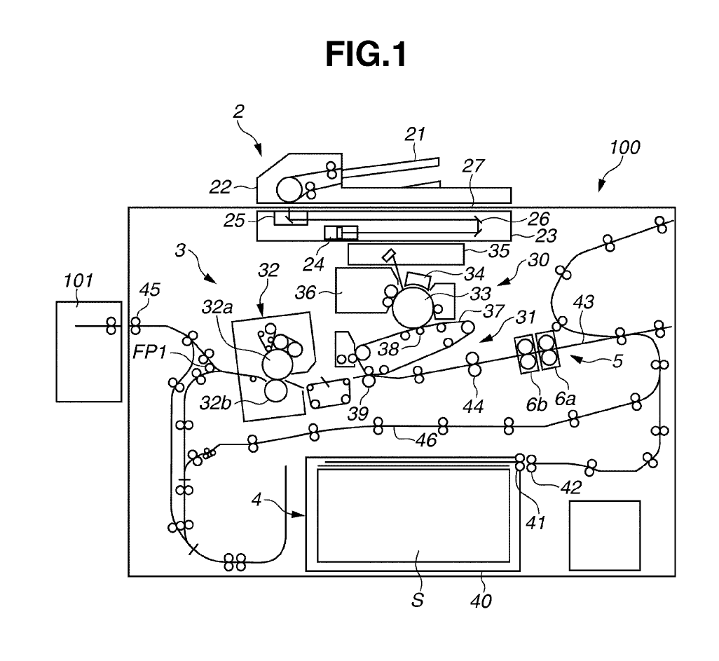

First, the general configuration of the printer 100 according to the exemplary embodiment will be described with reference to FIG. 1. FIG. 1 is a cross-sectional view schematically illustrating the overall configuration of the printer 100 according to the exemplary embodiment disclosed herein.

As illustrated in FIG. 1, the printer 100 includes an image reading unit 2 configured to read image information of a document, an image forming unit 3 configured to form an image based on the image information read by the image reading unit 2, a sheet feeding unit 4 configured to feed a sheet S, and a sheet compression apparatus 5 configured to press an edge portion of the sheet S.

The image reading unit 2 includes a document tray 21 where documents are stacked, a document feeding unit 22 configured to feed the documents stacked on the document tray 21 to a document holding unit 27, and a reader unit 23 configured to read the image information of the document fed by the document feeding unit 22 to the document holding unit 27. The reader unit 23 includes a first scanning unit 25 and a second scanning unit 26 configured to read an image, and an image sensor 24.

The image forming unit 3 includes an image forming unit main body 30 configured to form an image, a transfer unit 31 configured to transfer the image formed by the image forming unit main body 30 to the sheet S, and a fixing unit 32 configured to fix the image transferred by the transfer unit 31 to the sheet S. The image forming unit main body 30 includes a photosensitive drum 33 where a toner image is formed, a charger 34 configured to charge the photosensitive drum 33, a laser scanner unit 35 configured to form an electrostatic latent image on the photosensitive drum 33, and a development unit 36 configured to develop the toner image by developing the electrostatic latent image. The transfer unit 31 includes an intermediate transfer belt 37 configured to bear the toner image, a transfer charger 38 configured to transfer the toner image to the intermediate transfer belt 37, and a secondary transfer unit 39 configured to transfer the toner image transferred to the intermediate transfer belt 37 to the sheet S. The fixing unit 32 includes a fixing roller 32a having a built-in heater, and a pressure roller 32b contacting the fixing roller 32a with pressure.

The sheet feeding unit 4 includes a feeding cassette 40 configured to store the sheet S, a pickup roller 41 configured to pick up the sheet S from the feeding cassette 40, and a separation unit 42 configured to separate the sheets fed from the pickup roller 41 one by one. The sheet compression apparatus 5 is disposed on a sheet conveyance path 43 between the sheet feeding unit 4 and the image forming unit 3, and reduces the thickness of the sheet S by pressing the edge portion of the sheet S conveyed to the transfer unit 31. The sheet compression apparatus 5 will be described in detail below.

Next, an image forming operation of the printer 100 thus configured according to the present exemplary embodiment will be described. Upon an output of an image reading signal from a not-illustrated control unit to the image reading unit 2 in the printer 100 according to the present exemplary embodiment, a document placed on the document tray 21 is fed to the document holding unit 27 by a feeding roller. Upon the feeding of the document to the document holding unit 27, light is emitted to the document from a light source of the first scanning unit 25, and the light reflected from the document is input into the image sensor 24 via the first scanning unit 25 and the second scanning unit 26. The light input to the image sensor 24 is converted into an electrical signal as image information, and is transferred to the laser scanner unit 35.

Upon the transfer of the image information to the laser scanner unit 35, laser light corresponding to the image information is emitted to the photosensitive drum 33. At this time, the photosensitive drum 33 is charged in advance by the charger 34, and an electrostatic latent image is formed on the photosensitive drum 33 by the laser light emitted. Upon the formation of the electrostatic latent image on the photosensitive drum 33, the electrostatic latent image is developed by toner of the development unit 36, and is visualized as a toner image. The toner image on the photosensitive drum 33 is primarily transferred to the intermediate transfer belt 37 by the transfer charger 38 with a rotation of the photosensitive drum 33.

On the other hand, upon an output of a sheet feeding signal to the sheet feeding unit 4, the sheets S stored in the sheet feeding cassette 40 are fed by the pickup roller 41 while being separated one by one by the separation unit 42. The sheet S fed by the pickup roller 41 is conveyed to a registration roller pair 44 while the leading edge portion and the trailing edge portion of the sheet S are compressed by the sheet compression apparatus 5, and is conveyed to a secondary transfer unit 39 by the registration roller pair 44 at a predetermined timing. Sheet compression processing by the sheet compression apparatus 5 will be described in detail below.

The toner image on the intermediate transfer belt 37 is secondarily transferred to the sheet S conveyed to the secondary transfer unit 39 by secondary transfer bias applied by the secondary transfer unit 39. Then, the sheet S is conveyed to the fixing unit 32. The sheet conveyed to the fixing unit 32 receives heat and a pressure at the fixing unit 32, whereby the toner is melted and mixed to be fixed on the sheet S. After that, the sheet S with the image fixed thereon is discharged from the printer 1 by a discharge roller pair 45 disposed downstream of the fixing unit 32, and is transferred to a processing apparatus 101. Then, an image forming job by the printer 1 is completed.

To form images on both surfaces of the sheet S, after an unfixed toner image is fixed on the sheet S at the fixing unit 32, the sheet S is conveyed to a two-sided conveyance path 46 by switching a flapper FP1 before the sheet S is discharged by the discharge roller pair 45. The sheet S conveyed to the two-sided conveyance path 46 is conveyed to the image forming unit 3 again, and two-side printing is performed by a similar operation to the above-described operation.

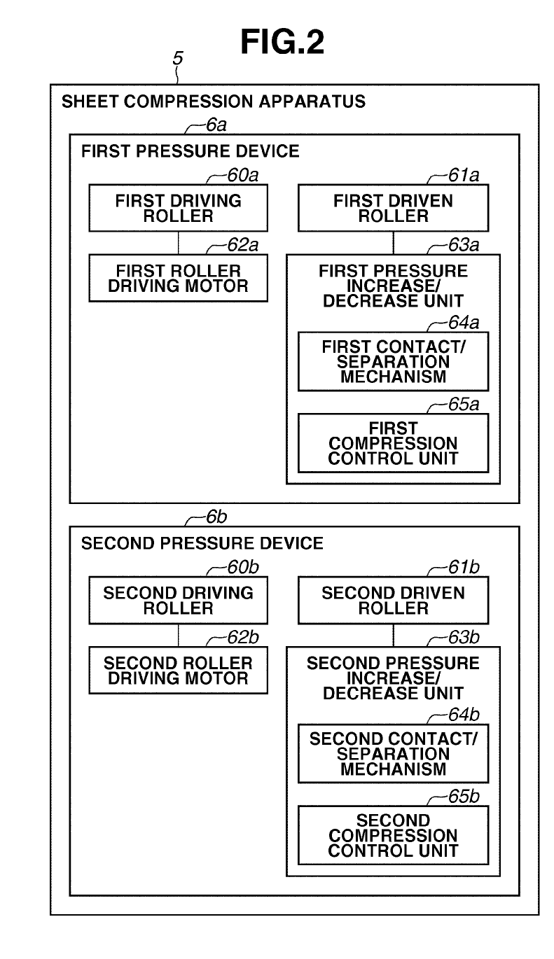

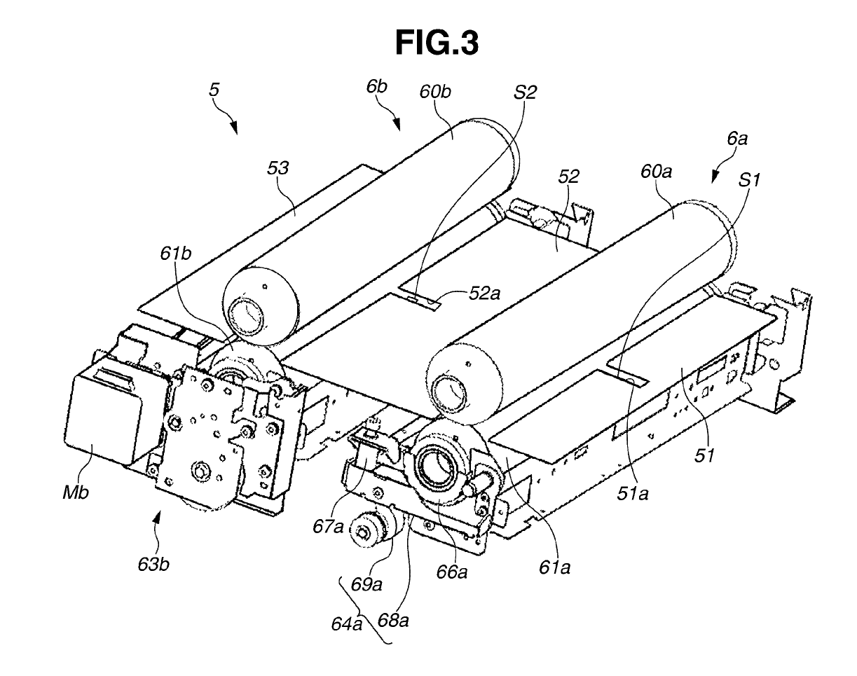

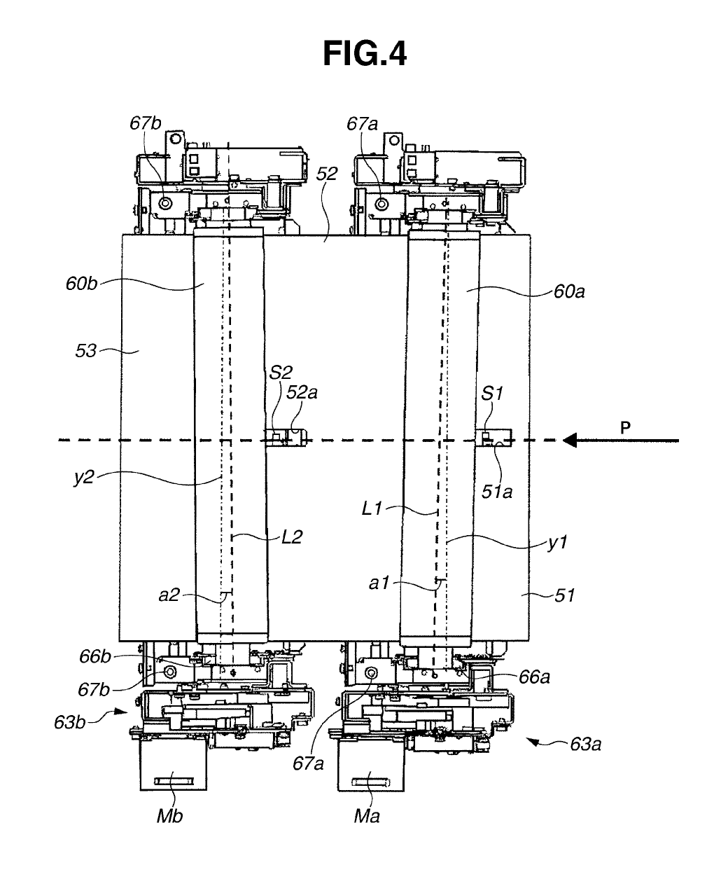

Next, the sheet compression apparatus 5 according to the present exemplary embodiment will be described with reference to FIGS. 2 to 4. FIG. 2 is a function block diagram of the sheet compression apparatus 5 according to the present exemplary embodiment. FIG. 3 is a perspective view illustrating the general configuration of the sheet compression apparatus 5 according to the present exemplary embodiment. FIG. 4 is a top view illustrating the sheet compression apparatus 5 according to the present exemplary embodiment.

As illustrated in FIGS. 2 to 4, the sheet compression apparatus 5 includes a first pressure device 6a configured to press the sheet S, from one end of the leading edge portion of the sheet S in the width direction, a second pressure device 6b configured to press the sheet S, from the other end in the width direction, and a sheet conveyance guide 50 configured to guide the sheet S.

The first pressure device 6a includes a first driving roller 60a and a first driven roller 61a as a first rotator pair, a first roller driving motor 62a configured to rotate the first driving roller 60a, and a first pressure increase/decrease unit 63a configured to move the first driven roller 61a to contact the first driving roller 60a or separate the first driven roller 61a from the first driving roller 60a. The first driving roller 60a and the first driven roller 61a constitute a first nip L1, which presses the sheet S. The first pressure device 6a is disposed in such a manner that the leading edge portion of the sheet S enters the first nip L at a plus angle a1 as a first angle relative to the first nip L1.

More specifically, the first driving roller 60a as one rotator is a metallic roller, and is rotatably supported by a not-illustrated side plate in such a state that the rotational axis of the first driving roller 60a is inclined at the plus angle a1 relative to the width direction orthogonal to a sheet conveyance direction P of the sheet conveyance path 43. In the present exemplary embodiment, as illustrated in FIG. 4, the first driving roller 60a is disposed in such a manner that the rotational axis thereof is inclined at the plus angle a1 relative to a perpendicular line y1 orthogonal to the sheet conveyance direction P of the sheet conveyance path 43. The plus angle indicates an angle at which the rotational axis is inclined to the downstream side relative to the perpendicular line orthogonal to the sheet conveyance direction P. On the other hand, a minus angle, which will be described below, indicates an angle at which the rotational axis is inclined to the upstream side opposite from the plus angle relative to the perpendicular line. Further, in the present exemplary embodiment, the first angle a1 and a second angle a2 are set to the same degree (one degree). However, the first angle a1 and the second angle a2 may be set to different degrees.

The first driving roller 60a forms the plus angle with one longitudinal end located downstream relative to the other longitudinal end. In the present exemplary embodiment, the plus angle a1 is an angle inclined at one degree to the downstream side relative to the perpendicular line y1. Further, the first roller driving motor 62a is connected to the one end of the first driving roller 60a via a not-illustrated gear, and the first roller driving motor 62a rotates the first driving roller 60a. The first pressure device 6a is set in such a manner that the first roller driving motor 62a is rotated faster than the second roller driving motor 62b of the second pressure device 6b, whereby the conveyance speed at the first nip L1 becomes equal to or higher than the conveyance speed at the second nip L2.

The first driven roller 61a as the other rotator is rotatably supported by the first pressure increase/decrease unit 63a in parallel with the rotational axis of the first driving roller 60a. In other words, the first driven roller 61a is supported by the first pressure increase/decrease unit 63a in such a state that the rotational axis of the first driven roller 61a is inclined at the plus angle a1 relative to the width direction orthogonal to the sheet conveyance direction P of the sheet conveyance path 43. In the present exemplary embodiment, the first driven roller 61a is disposed in such a manner that the rotational axis thereof is inclined at the plus angle a1 relative to the perpendicular line y1.

The first pressure increase/decrease unit 63a includes a first contact/separation mechanism 64a as a first variable pressure mechanism configured to move the first driven roller 61a toward the first driving roller 60a, and the first compression control unit 65a configured to control the first contact/separation mechanism 64a. The first contact/separation mechanism 64a includes a roller arm 66a rotatably supporting the first driven roller 61a, an elevating arm 68a coupled to the roller arm 66a via a pressure spring 67a, and a retraction cam 69a disposed at each of both ends of a cam shaft. Further, the first contact/separation mechanism 64a includes a first pressing motor Ma configured to rotate the retraction cam 69a, and a first sensor S1 configured to detect the leading edge position of the sheet S.

The elevating arm 68a is rotatably supported by a hinge shaft fixed to a frame as a fulcrum, and moves the roller arm 66a by rotating around the hinge shaft. In other words, a rotation of the elevating arm 68a causes the first driven roller 61a supported by the roller arm 66a to move vertically, thereby establishing a high pressing force state, which increases (changes) the pressing force of the first nip L1, and a low pressing force state, which decreases (changes) the pressing force of the first nip L1. In the high pressing force state, the first pressure device 6a conveys the sheet S while compressing the sheet S. On the other hand, in the low pressing force state, the first pressure device 6a conveys the sheet S without compressing the sheet S.

The retraction cam 69a is in abutment with the elevating arm 68a, and pushes up the elevating arm 68a by a rotation of the cam shaft connected to the first pressing motor Ma. The first driven roller 61a is set in the high pressing force state when the top dead center of the retraction cam 69a is located at a highest point, and is set in the low pressing force state when the top dead center of the retraction cam 69a is located at a lowest point. In the present exemplary embodiment, the pressing force in the high pressing force state is set to approximately 100 kg, and the pressing force in the low pressing force state is set to approximately 1 kg. When the first nip L1 of the first driving roller 60a and the first driven roller 61a is in the low pressing force state, the first driving roller 60a and the first driven roller 61a serve as a conveyance roller that conveys the sheet S. The first sensor S1 is disposed upstream of the first nip L1 of the first driving roller 60a and the first driven roller 61a, and detects the leading edge position of the sheet S being conveyed.

The first compression control unit 65a controls the first pressing motor Ma to move the first driven roller 61a, thereby switching the first pressure device 6a between the high pressing force state and the low pressing force state.

The second pressure device 6b includes a second driving roller 60b and a second driven roller 61b as a second rotator, a second roller driving motor 62b configured to rotate the second driving roller 60b, and a second pressure increase/decrease unit 63b configured to move the second driven roller 61b to contact the second driving roller 60b or separate the second driven roller 61b from the second driving roller 60b. The second driving roller 60b and the second driven roller 61b constitute a second nip L2, which presses the sheet S. The second pressure device 6b is disposed in such a manner that the leading edge portion of the sheet S enters the second nip L2 at a minus angle a2 as a second angle relative to the second nip L2. The second nip L2 is formed so as to be inclined to the opposite side from the first nip L1.

More specifically, the second driving roller 60b is a metallic roller, and is rotatably supported by a not-illustrated side plate in such a state that the rotational axis of the second driving roller 60b is inclined at the minus angle a2 relative to the width direction orthogonal to the sheet conveyance direction P of the sheet conveyance path 43. In the present exemplary embodiment, as illustrated in FIG. 4, the second driving roller 60b is disposed in such a manner that the rotational axis thereof is inclined at the minus angle a2 relative to a perpendicular line y2 orthogonal to the sheet conveyance direction P of the sheet conveyance path 43.

The second driving roller 60b forms the minus angle with one longitudinal end located upstream relative to the other longitudinal end. In the present exemplary embodiment, the minus angle a2 is an angle inclined at one degree to the upstream side relative to the perpendicular line y2. Further, the second roller driving motor 62b is connected to the one end of the second driving roller 60b via a not-illustrated gear, and the second roller driving motor 62b rotates the second driving roller 60b.

The second driven roller 61b is rotatably supported by the second pressure increase/decrease unit 63b in parallel with the rotational axis of the second driving roller 60b. In other words, the second driven roller 61b is supported by the second pressure increase/decrease unit 63b in such a state that the rotational axis of the second driven roller 61b is inclined at the minus angle a2 relative to the width direction orthogonal to the sheet conveyance direction P of the sheet conveyance path 43. In the present exemplary embodiment, the second driven roller 61b is disposed in such a manner that the rotational axis thereof is inclined at the minus angle a2 relative to the perpendicular line y2.

The second pressure increase/decrease unit 63b includes a second contact/separation mechanism 64b as a second variable pressure mechanism configured to move the second driven roller 61b toward the second driving roller 60b, and the second compression control unit 65b configured to control the second contact/separation mechanism 64b. The second contact/separation mechanism 64b includes a roller arm 66b rotatably supporting the second driven roller 61b, an elevating arm 68b coupled to the roller arm 66b via a pressure spring 67b, and a retraction cam 69b disposed at each of both ends of a cam shaft. Further, the second contact/separation mechanism 64b includes a second pressing motor Mb configured to rotate the retraction cam 69b, and a second sensor S2 configured to detect the leading edge position of the sheet S.

The elevating arm 68b is rotatably supported by a hinge shaft fixed to a frame as a fulcrum, and moves the roller arm 66b by rotating around the hinge shaft. In other words, a rotation of the elevating arm 68b causes the second driven roller 61b supported by the roller arm 66b to move vertically, thereby establishing the high pressing force state, which increases (changes) the pressing force of the second nip L2, and the low pressing force state, which decreases (changes) the pressing force of the second nip L2. In the high pressing force state, the second pressure device 6b conveys the sheet S while compressing the sheet S. On the other hand, in the low pressing force state, the second pressure device 6b conveys the sheet S without compressing the sheet S.

The retraction cam 69b is in abutment with the elevating arm 68b, and pushes up the elevating arm 68b by a rotation of the cam shaft connected to the second pressing motor Mb. The second driven roller 61b is set in the high pressing force state when the top dead center of the retraction cam 69b is located at a highest point, and is set in the low pressing force state when the top dead center of the retraction cam 69b is located at a lowest point. In the present exemplary embodiment, the pressing force in the high pressing force state is set to approximately 100 kg, and the pressing force in the low pressing force state is set to approximately 1 kg. When the second nip L2 of the second driving roller 60b and the second driven roller 61b is in the low pressing force state, the second driving roller 60b and the second driven roller 61b serve as a conveyance roller that conveys the sheet S. The second sensor S2 is disposed upstream of the second nip L2 of the second driving roller 60b and the second driven roller 61b, and detects the leading edge position of the sheet S being conveyed.

The second compression control unit 65b controls the second pressing motor Mb to move the second driven roller 61b, thereby switching the second pressure device 6b between the high pressing force state and the low pressing force state.

The sheet conveyance guide includes a first conveyance guide 51 configured to guide the sheet S to the first nip L1 of the first pressure device 6a, and a second conveyance guide 52 configured to guide the sheet S conveyed from the first nip L1 of the first pressure device 6a to the second nip L2 of the second pressure device 6b. Further, the sheet conveyance guide includes a third conveyance guide 53 configured to guide the sheet S conveyed from the second nip L2 of the second pressure device 6b toward the nip of the registration roller pair 44. The first conveyance guide 51 is disposed upstream of the first pressure device 6a, and includes a cutout portion 51a allowing the first sensor S1 to be exposed. The second conveyance guide 52 is disposed upstream of the second pressure device 6b, and is arranged between the first pressure device 6a and the second pressure device 6b. The second conveyance guide 52 includes a cutout portion 52a allowing the second sensor S2 to be exposed.

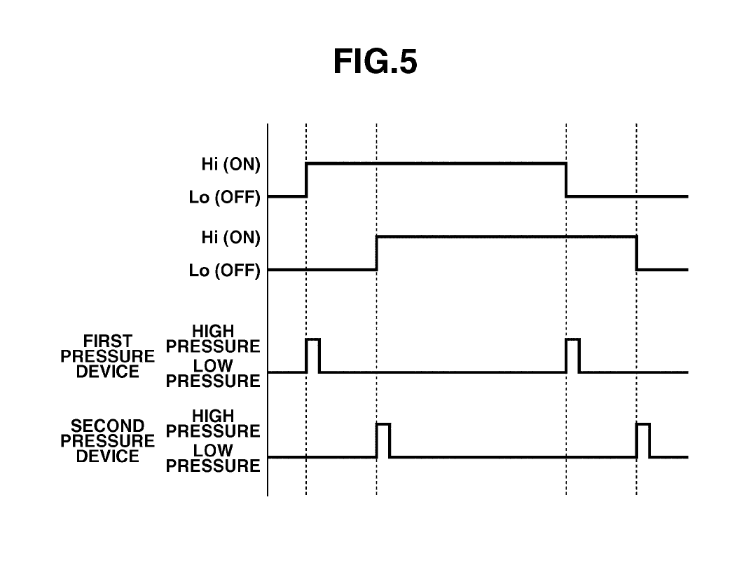

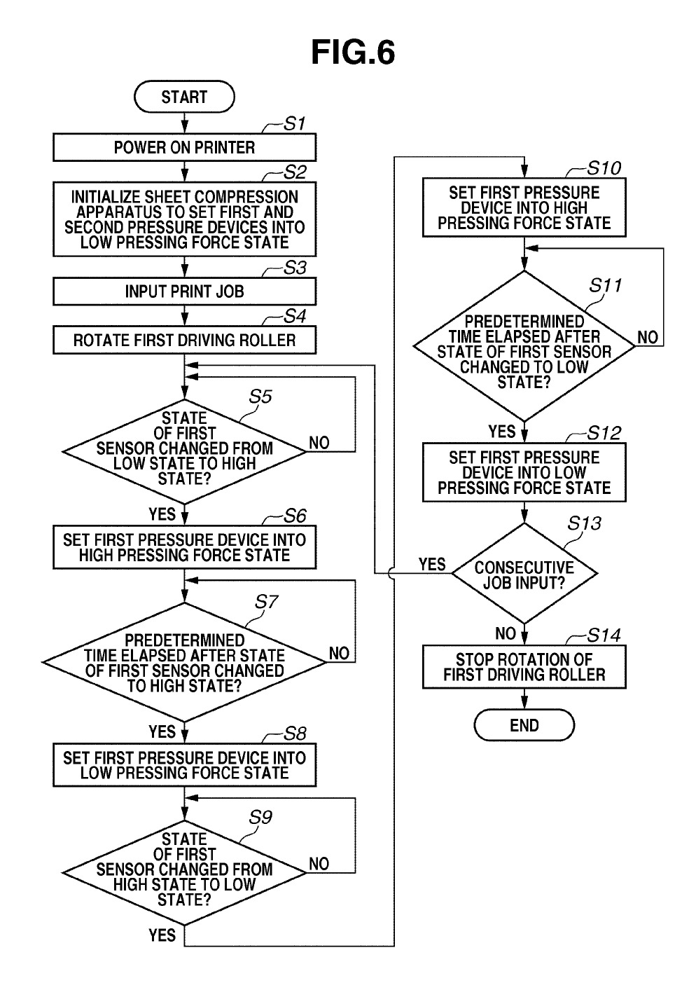

Next, the sheet compression processing by the sheet compression apparatus 5 according to the present exemplary embodiment will be described with reference to FIGS. 5 and 6. FIG. 5 is a timing chart illustrating an increase and decrease of the pressing force of the sheet compression apparatus 5 according to the present exemplary embodiment. FIG. 6 is a flowchart illustrating the sheet compression operation of the sheet compression apparatus 5 according to the present exemplary embodiment.

As illustrated in FIG. 5, the sheet compression apparatus 5 is configured in such a manner that the first sensor S1 detects the sheet S to be switched from a Low (Lo) state (OFF) to a High (Hi) state (ON), thereby changing the pressing force of the first nip L1 from the low pressing force state to the high pressing force state. This switching is controlled to be completed before the leading edge portion of the sheet S is inserted into the first nip L1. In other words, by the time that the leading edge portion of the sheet S is inserted into the first nip L1, the first pressure device 6a is already set in the high pressing force state. Further, when a predetermined time has elapsed after the sheet S is inserted into the first nip L1, the state of the first pressure device 6a is changed from the high pressing force state to the low pressing force state. The predetermined time described here is a time from when the state of the first sensor S1 is switched to the Hi state (ON) until when the leading edge portion of the sheet S exits from the first nip L1.

Next, after the state of the first sensor S1 is switched from the Hi state (ON) to the Lo state (OFF), the pressing force of the first pressure device 6a is changed again from the low pressing force state to the high pressing force state. This switching is controlled to be completed before the trailing edge portion of the sheet S is inserted into the first nip L1. In other words, by the time that the trailing edge portion of the sheet S is inserted into the first nip L1, the first pressure device 6a is already set in the high pressing force state. Then, after the trailing edge portion of the sheet S exits from the first nip L1, the sheet compression apparatus 5 changes the state of the first pressure device 6a from the high pressing force state to the low pressing force state.

Similarly, the sheet compression apparatus 5 is configured in such a manner that the second sensor S2 detects the sheet S to be switched from the Lo state (OFF) to the Hi state (ON), thereby changing the pressing force of the second nip L2 from the low pressing force state to the high pressing force state. This switching is controlled to be completed before the leading edge portion of the sheet S is inserted into the second nip L2. In other words, by the time that the leading edge portion of the sheet S is inserted into the second nip L2, the second pressure device 6b is already set in the high pressing force state. Further, when a predetermined time has elapsed after the leading edge portion of the sheet S is inserted into the second nip L2, the state of the second pressure device 6b is changed from the high pressing force state to the low pressing force state. The predetermined time described here is a time from when the state of the second sensor S2 is switched to the Hi state (ON) until when the leading edge portion of the sheet S exits from the second nip L2.

Next, after the state of the second sensor S1 is switched from the Hi state (ON) to the Lo state (OFF), the pressing force of the second pressure device 6b is changed from the low pressing force state to the high pressing force state. This switching is controlled to be completed before the trailing edge portion of the sheet S is inserted into the second nip L2. In other words, by the time that the trailing edge portion of the sheet S is inserted into the second nip L2, the second pressure device 6b is already set in the high pressing force state. Then, after the trailing edge portion of the sheet S exits from the second nip L2, the state of the second pressure device 6b is changed from the high pressing force state to the low pressing force state.

Next, the sheet compression operation by the sheet compression apparatus 5 will be described with reference to FIG. 6. As illustrated in FIG. 6, in step S1, the printer 100 is powered on. Then, in step S2, the sheet compression apparatus 5 is initialized (initial operation). More specifically, the first compression control unit 65a controls the first pressing motor Ma to set the first pressure device 6a into the low pressing force state, and the second compression control unit 65b controls the second pressing motor Mb to set the second pressure device 6b into the low pressing force state.

Subsequently, in step S3, a print job is input in the printer 100. Then, in step S4, the first roller driving motor 62a is controlled to rotate the first driving roller 60a. Subsequently, in step S5, if the first sensor S1 detects the sheet S so that the state of the first sensor S1 is switched from the Lo state (OFF) to the Hi state (ON) (YES in step S5), in step S6, the first compression control unit 65a controls the first pressing motor Ma to set the first pressure device 6a into the high pressing force state. This switching is completed before the leading edge portion of the sheet S is inserted into the first nip L1. As a result, the leading edge portion of the sheet S is pressed.

By the time that the leading edge portion of the sheet S is inserted into the first nip L1, the first pressure device 6a is already set in the high pressing force state, whereby the sheet S is pressed, from the leading edge portion thereof. The first driving roller 60a and the first driven roller 61a of the first pressure device 6a are disposed in such a manner that the first nip L1 is inclined at the plus angle a1 relative to the perpendicular line y1 orthogonal to the sheet conveyance direction P. Therefore, the leading edge portion of the sheet S conveyed in the sheet conveyance direction P enters the first nip L1 in the sheet width direction and is pressed by the first nip L1 first. Then, in step S7, if the leading edge portion of the sheet S exits from the first nip L1 (if the predetermined time has elapsed after the first pressure device 6a is set in the high pressing force state) (YES in step S7), in step S8, the first compression control unit 65a controls the first pressing motor Ma to set the first pressure device 6a into the low pressing force state.

Subsequently, the sheet S is conveyed through the first pressure device 6a in the low pressing force state, and in step S9, if the state of the first sensor S1 is switched from the Hi state (ON) to the Lo state (OFF) (YES in step S9), in step S10, the first compression control unit 65a controls the first pressing motor Ma to set the first pressure device 6a into high pressing force state. As a result, the trailing edge portion of the sheet S is pressed. Before the trailing edge portion of the sheet S is inserted into the first nip L1, the first pressure device 6a is already set in the high pressing force state, whereby the entire trailing edge portion of the sheet S is pressed.

Further, the first driving roller 60a and the first driven roller 61a are disposed in such a manner that the first nip L1 thereof is inclined at the plus angle a1 relative to the perpendicular line y1 orthogonal to the sheet conveyance direction P. Therefore, the trailing edge portion of the sheet S conveyed in the sheet conveyance direction P enters the first nip L1 in such a manner that the other end of the trailing edge portion of the sheet S in the sheet width direction is pressed last. Then, in step S11, if the trailing edge portion of the sheet S exits from the first nip L1 (if the predetermined time has elapsed after the first pressure device 6a is set in the high pressing force state) (YES in step S11), in step S12, the first compression control unit 65a controls the first pressing motor Ma to set the first pressure device 6a into the low pressing force state.

Subsequently, in step S13, if a consecutive job is input and there is a subsequent sheet (YES in step S13), the processing proceeds to step S5 again. Then, the above-described steps are repeated. On the other hand, if a consecutive job is not input (NO in step S13), in step S14, the rotation of the first driving roller is stopped, thereby ending the sheet compression operation by the first compression control unit 65a of the first pressure device 6a.

After the end of the sheet compression operation by the first compression control unit 65a of the first pressure device 6a, the sheet compression operation by the second compression control unit 65b of the second pressure device 6b is started. The sheet compression operation by the second compression control unit 65b of the second pressure device 6b is similar to the operation by the first pressure device 6b, except that the leading edge portion of the sheet S passes through the second nip L in such a manner that the other end of the leading edge portion of the sheet S in the sheet width direction enters the second nip L2 and is pressed by the second nip L2 first. Therefore, the description thereof will be omitted here.

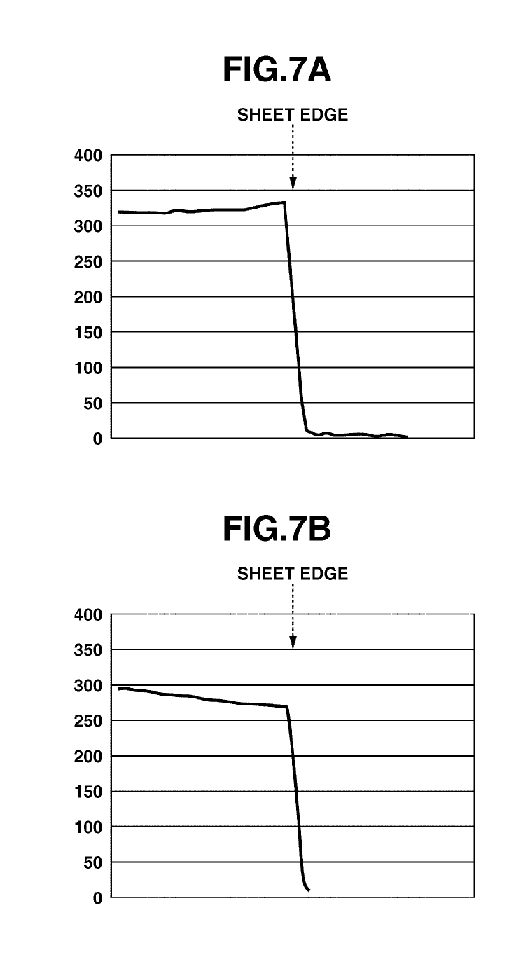

FIGS. 7A and 7B illustrate a result of measurement indicating the thickness of the leading edge portion of the sheet S measured before the sheet S is conveyed through the sheet compression apparatus 5 and after the sheet S is conveyed through the sheet compression apparatus 5. FIG. 7A illustrates the thickness of the leading edge portion of the sheet S before the sheet S is conveyed through the sheet compression apparatus 5. FIG. 7B illustrates the thickness of the leading edge portion of the sheet S after the sheet S is conveyed through the sheet compression apparatus 5.

As illustrated in FIGS. 7A and 7B, this measurement indicates that the height of the leading edge portion of the sheet S is reduced by the conveyance of the sheet S through the sheet compression apparatus 5, compared to the height of the leading edge portion of the sheet S before this conveyance. This measurement also indicates that, similarly, at the trailing edge portion of the sheet S, the height of the trailing edge portion of the sheet S is reduced by the conveyance of the sheet S through the sheet compression apparatus 5.

As described above, the printer 100 according to the present exemplary embodiment includes the first pressure device 6a, which allows an entry of the leading edge portion of the sheet S and presses the leading edge portion of the sheet S at the first angle a1 inclined relative to the first nip L1. Therefore, it is possible to cause the one end of the leading edge portion of the sheet S in the width direction to enter the first nip L1 first, although the sheet S is conveyed in such a manner that the leading edge portion thereof moves orthogonally relative to the sheet conveyance path 43. As a result, for example, even at the time of conveyance of a thick sheet having a grammage exceeding 300 g/m² (gsm), the edge portion of the sheet S can be compressed without unnecessarily increasing the torque of the roller pair. Further, the entry of the sheet S into the first nip L1 at the first angle a1 enables a reduction of the shock at the moment of the entry of the sheet S, thereby preventing occurrence of a sheet conveyance failure.

Further, the printer 100 includes the second pressure device 6b, which allows an entry of the leading edge portion of the sheet S and presses the leading edge portion of the sheet S at the second angle a2 inclined relative to the second nip L2 to the opposite side from the first nip L1, disposed downstream of the first pressure device 6a. Therefore, it is possible to cause the other end of the leading edge portion of the sheet S in the width direction to enter the second nip L2 first at the time of the entry of the leading edge portion of the sheet S with the one end pressed by the first nip L1. Due to this configuration, the ends of the leading edge portion of the sheet S can be compressed from the both sides in the sheet width direction. Thus, the leading edge portion of the sheet S can be evenly compressed.

Further, the first angle a1 and the second angle a2 are formed to be the same degree. Therefore, even if the sheet S become inclined at the first nip L1, the sheet S becomes inclined to the opposite direction at the second nip L2, thereby allowing the sheet S to return to the original position.

Further, the first pressure device 6a includes the first contact/separation mechanism 64a capable of setting the first rotator pair into the contacted state and the separated state. Thus, it is possible to switch the state of the first nip L1 between the high pressing force state in which the sheet S is pressed and the low pressing force state in which the sheet is conveyed. As a result, it becomes possible to press the sheet S only when necessary, and for example, it becomes possible to save power consumption. This advantageous effect also applies to the second pressure device 6b.

Further, the first contact/separation mechanism 64a moves the first driven roller 61a toward the first driving roller 60a by rotating the retraction cam 69a. Therefore, for example, it is possible to adjust the pressing force of the first nip L1 according to the shape of the cam surface of the retraction cam 69a. Further, it is also possible to adjust the pressing force of the first nip L1 according to the rotation amount of the retraction cam 69a. Thus, it is possible to prevent the first pressure device 6a from unnecessarily pressing the sheet S.

Further, the conveyance speed at the first nip L1 is set so as to be higher than the conveyance speed at the second nip L2. Therefore, for example, even when the sheet S is held by both the first nip L1 and the second nip L2, it is possible to prevent the sheet S held by the first nip L1 from being pulled by the second nip L2 by forming a loop between the first nip L1 and the second nip L2.

Having described the exemplary embodiment, it is noted that the present disclosure is not limited to the above-described exemplary embodiment. Further, the advantageous effects have been described in the description of the exemplary embodiment of the present disclosure, but this is merely enumeration of effective ones among the effects provided by the present disclosure. The advantageous effects of the present disclosure are not limited to those described in the description of the exemplary embodiment disclosed herein.

For example, the present exemplary embodiment is configured to press only the leading edge portion and the trailing edge portion of the sheet S, but the present invention is not limited thereto. For example, the sheet compression apparatus 5 may be set to press the entire sheet S. Pressing the entire sheet S allows even the side edge portion of the sheet S to be effectively compressed.

Further, in the present exemplary embodiment, the first angle a1 and the second angle a2 are formed to be the same degrees, but the present invention is not limited thereto. The first angle a1 and the second angle a2 may be set to different degrees.

Further, in the present exemplary embodiment, the sheet S is conveyed in such a manner that the leading edge portion of the sheet S moves orthogonally to the sheet conveyance direction P, but the present disclosure is not limited thereto.

The present invention can be achieved just by conveying the sheet S in such a manner that the sheet S enters the first nip L1 at the first angle a1 relative to the first nip L1 and enters the second nip L2 at the second angle a2 relative to the second nip L2. For example, the sheet compression apparatus 5 may be configured in such a manner that the sheet S is conveyed in an inclined state.

Further, the present exemplary embodiment has been described as an example using the first contact/separation mechanism 64a and the second contact/separation mechanism 64b including the rotatable retract cams 69a and 69b, but the present disclosure is not limited thereto. For example, the sheet compression apparatus 5 may be configured to directly drive the first and second rotator pairs by, for example, a motor.

While described with reference to exemplary embodiments, it is to be understood that the disclosure is not limited to the disclosed exemplary embodiments. The scope of the following claims is to be accorded the broadest interpretation so as to encompass all modifications, equivalent structures, and functions.

This application claims priority from Japanese Patent Application No. 2011-179062 filed Aug. 18, 2011, which is hereby incorporated by reference herein in its entirety.

What is claimed is:

1. An image forming apparatus comprising:
a sheet feeding unit configured to feed a sheet;
an image forming unit configured to form an image on the sheet fed by the sheet feeding unit; and
a sheet compression apparatus disposed between the sheet feeding unit and the image forming unit and configured to compress the sheet fed by the sheet feeding unit before the image forming unit forms the image on the sheet,
wherein the sheet compression apparatus includes:
a first rotator pair including a first nip configured to press the sheet, the first rotator pair allowing a leading edge portion of the sheet to enter and pass through the first nip at a first angle inclined relative to the first nip; and
a second rotator pair including a second nip configured to press the sheet, the second rotator pair allowing the leading edge portion of the sheet to enter and pass through the second nip at a second angle inclined opposite the first angle relative to the second nip.

2. The image forming apparatus according to claim 1, wherein the sheet is conveyed so the leading edge portion of the sheet moves orthogonally with respect to a sheet conveyance direction, and
wherein the first rotator pair and the second rotator pair are disposed to be respectively inclined relative to the sheet conveyance direction so the first angle and the second angle are the same degree.

3. The image forming apparatus according to claim 1, further comprising:
a first variable pressure mechanism configured to change a pressure of one rotator to be applied to the other rotator of the first rotator pair; and
a second variable pressure mechanism configured to change a pressure of one rotator to be applied to the other rotator of the second rotator pair.

4. The image forming apparatus according to claim 1, wherein a sheet conveyance speed of the first rotator pair is set to be greater than a sheet conveyance speed of the second rotator pair.

5. A sheet compression apparatus disposed between a sheet feeding unit configured to feed a sheet and an image forming unit configured to form an image on the sheet fed by the sheet feeding unit, the sheet compression apparatus being configured to compress the sheet fed by the sheet feeding unit before the image forming unit forms the image on the sheet, the sheet compression apparatus comprising:
a first rotator pair including a first nip configured to press the sheet, the first rotator pair allowing a leading edge portion of the sheet to enter and pass through the first nip at a first angle inclined relative to the first nip; and
a second rotator pair including a second nip configured to press the sheet, the second rotator pair allowing the leading edge portion of the sheet to enter and pass through the second nip at a second angle inclined opposite to the first angle and relative to the second nip.

6. The sheet compression apparatus according to claim 5, wherein the sheet is conveyed so the leading edge portion of the sheet moves orthogonally with respect to a sheet conveyance direction, and
wherein the first rotator pair and the second rotator pair are disposed to be respectively inclined relative to the sheet conveyance direction so the first angle and the second angle are the same degree.

7. The sheet compression apparatus according to claim 5, further comprising:
a first variable pressure mechanism configured to change a pressure of one rotator to be applied to the other rotator of the first rotator pair; and
a second variable pressure mechanism configured to change a pressure of one rotator to be applied to the other rotator of the second rotator pair.

8. The sheet compression apparatus according to claim 5, wherein a sheet conveyance speed of the first rotator pair is set to be greater than a sheet conveyance speed of the second rotator pair.
